(19) United States
(12) Patent Application Publication
(10) Pub. No.: US 2016/0285579 A1
(43) Pub. Date: Sep. 29, 2016

(54) Optical Transmission Apparatus, Method, and Applications Thereof

(71) Applicant: UNIVERSITY OF CENTRAL FLORIDA RESEARCH FOUNDATION, INC., Orlando, FL (US)

(72) Inventors: Guifang Li, Orlando, FL (US); He Wen, Orlando, FL (US)

(73) Assignee: UNIVERSITY OF CENTRAL FLORIDA RESEARCH FOUNDATION, INC., Orlando, FL (US)

(21) Appl. No.: 15/078,174

(22) Filed: Mar. 23, 2016

Related U.S. Application Data
(60) Provisional application No. 62/167,397, filed on May 28, 2015.
(60) Provisional application No. 62/136,848, filed on Mar. 23, 2015.

(51) Int. Cl. H04J 14/02; H04J 14/04; H04B 10/25

(52) U.S. Cl. CPC H04J 14/02; H04B 10/2504; H04J 14/04

(57) ABSTRACT

Analog and digital fiber-optic telecommunication links using high-order modes in few-mode fibers (FMFs) to improve the Spurious Free Dynamic Range (SFDR) and reduce wavelength division multiplexing (WDM) penalties due to fiber nonlinearities. Methods and applications.

### RELATED APPLICATION DATA

The instant application claims priority to US Provisional Application No. 62/136,848 filed on 03/23/2015 and US Provisional Application No. 62/167,397 filed on 05/28/2015, the subject matters of which are incorporated by reference in their entireties.

### GOVERNMENT FUNDING

N/A.

### BACKGROUND

Aspects and embodiments of the invention generally pertain to optical communication apparatus and methods and, more particularly to analog and digital fiber optic transmission apparatus (e.g., transmission systems, fiber optic transmission links), transmission methods, and applications thereof enabled by increased spurious free dynamic range (SFDR) and reduced wavelength division multiplexing (WDM) penalties due to fiber nonlinearities.

The ability to achieve high RF gain, low noise figure and large dynamic range simultaneously determines the roles analog fiber-optic links can play in many potential commercial and military applications such as access networks, antenna remoting, radar signal distribution, and radio astronomy. Assuming noise figure can be maintained, analog links with higher RF gain can be used to increase the splitting ratio in distribution networks to support more users, thus reducing cost per user. For phased-arrayed antennas connected by analog fiber-optic links, high RF gain can support more antenna units, leading to narrower beam width and higher spatial resolution. For some applications such as access networks, especially those providing coverage to rural mountain areas and costal islets, the requirements become even more stringent as analog transmission distances reach several tens of kilometers.

It is well recognized that increasing the optical power before photon detection is the most effective way to simultaneously achieve high RF gain, low noise figure, and large dynamic range. Moreover, increasing optical power at the transmitter is preferred over optical preamplification at the receiver since the noise figure of the preamplified analog fiber-optic link is reduced by a factor equal to the gain of the preamplifier due to amplified spontaneous emission noise. Unfortunately, fiber nonlinearity becomes an impairment at moderate input powers and transmission distances; for example, the input power threshold for stimulated Brillouin scattering (SBS) is on the order of a few mW and a self-phase modulation of 0.1 radian is induced for an input power of 100 mW over 1 km of standard single-mode fiber (SMF). For wavelength-division multiplexed (WDM) switching and distribution networks for analog signals, cross-phase modulation (XPM) and four-wave mixing (FWM) result in additional fiber nonlinearity penalties.

In digital transmission, fiber nonlinearity would bring noise-like intra- and interchannel nonlinear crosstalk as well as signal distortion both in amplitude and phase. With coherent detection and the ability to compensate linear impairments of optical transmission systems, combating fiber nonlinearity if the last frontier in digital optical communication.

It is well known that Kerr nonlinearity in fiber fundamentally limits the performance of fiber optic telecommunications systems. The nonlinear polarization vector is given by:

P̅_{NL}=ε₀χ⁽³⁾·ĒĒĒ,

where χ⁽³⁾ is the third-order susceptibility. In an example case, four WDM channels are all polarized in the x direction given by:

$$\vec{E} = \frac{1}{2} \hat{x} {\sum }_{k = 1}^{4} {E}_{k} {ψ}_{k} exp [ j ( {ω}_{k} t - {β}_{k} z ) ] + c . c . ,$$

where Eₖ, ψₖ, ωₖ, βₖ are, respectively, the amplitude, the mode profile, angular frequency, and propagation constant of the k^{th} WDM channel. The nonlinear polarization is given by

$$\vec{P} = \frac{1}{2} \hat{x} {\sum }_{k = 1}^{4} {P}_{k} {ψ}_{k} exp [ j ( {ω}_{j} t - {β}_{j} z ) ] + c . c .$$

In particular, the amplitude of the nonlinear polarization in the 4^{th} wave is given by

$${P}_{4} = \frac{3 {ɛ}_{0}}{4} {χ}_{xxxx}^{( 3 )} [ \begin{matrix}\overbrace{{\vert {E}_{4} {ψ}_{4} \vert}^{2} {E}_{4} {ψ}_{4}}^{SPM} + \overbrace{2 ( {\vert {E}_{1} {ψ}_{1} \vert}^{2} + {\vert {E}_{2} {ψ}_{2} \vert}^{2} + {\vert {E}_{3} {ψ}_{3} \vert}^{2} ) {E}_{4} {ψ}_{4}}^{XPM} + \\ 2 {E}_{1} {ψ}_{1} {E}_{2} {ψ}_{2} {E}_{3} {ψ}_{3} exp ( {jθ}_{+} ) + 2 {E}_{1} {ψ}_{1} {E}_{2} {ψ}_{2} {E}_{3}^{*} {ψ}_{3}^{*} exp ( {jθ}_{-} ) + …\end{matrix} ] ,$$

where θ_{±}(ω₁+ω₂±ω₃−ω₄)l−(β₁+β₂±β₃−β₄)z. Most efficient energy- and moment-conserved FWM processes require (ω₁+ω₂±ω₃−ω₄)=0 and (β₁+β₂±β₃−β₄)=0.

The effect of cross-phase modulation depends on the overlap integral of the mode intensity profiles. For example, the efficiency of XPM of wave 4 due to wave 1 is proportional to C_{XPM}=∫∫|ψ₁|²|ψ₄|²dxdy. If wave 1 and wave 4 are in the same spatial mode, then the overlapping integral is much stronger than if wave 1 and wave 4 are in different spatial modes.

For four-wave mixing (FMW) of copolarized input signals, one can assume that the input signals are not depleted by the generation of mixing products; the peak power of the mixing product is given by (in MKS)

$${P}_{ijk} = {( \frac{{D}_{ijk}}{3} γ {L}_{eff} )}^{2} {P}_{i} {P}_{j} {P}_{k} {e}^{- α L} η ,$$

where Dᵢⱼₖ=3 for two-tone products and 6 for three-tone products. The efficiency η is given by:

$$η = \frac{{α}^{2}}{{α}^{2} + Δ {β}^{2}} [ 1 + \frac{4 {e}^{- α L} {sin}^{2} ( Δ β L / 2 )}{{( 1 - {e}^{- α L} )}^{2}} ] {C}_{FWM} ( {ψ}_{i} , {ψ}_{j} , {ψ}_{k} , {ψ}_{ijk} ) .$$

The efficiency is inversely proportional to Δβ, the difference of the propagation constants of the various waves, given by Δβ=βᵢ+βⱼ−βₖ−βᵢⱼₖ, and

C_{FWM}(ψᵢ, ψⱼ, ψₖ, ψᵢⱼₖ)=∫∫ψᵢψⱼψₖ*ψᵢⱼₖ*dxdy.

As for the case of XPM, the overlapping integral would be the strongest if all waves are in the same spatial modes.

In FWM, the phase mismatch αβ can have a strong effect on the overall efficiency. When at least one of the four waves is in a different spatial mode, phase mismatching will be very large, leading to reduced FWM products.

In view of the foregoing discussion, the inventors have recognized the benefits and advantages of achieving improved SFDR for single-channel analog transmission and reducing nonlinear penalties (cross-phase modulation and four-wave mixing) for analog and digital WDM systems.

The embodied apparatus, methods, and applications described in detail below and as recited in the appended claims enable the realization of such benefits and advantages as well as others appreciated by those skilled in the art.

### SUMMARY OF THE EMBODIED INVENTION

An aspect of the invention is an analog fiber optic telecommunications link. According to an embodiment, the analog fiber optic telecommunications link includes a spatial mode multiplexer having an input and an output; and, a length of a few mode fiber (FMF) having an input end, wherein the output of the spatial mode multiplexer is optically coupled to the input of the FMF. In various embodiments, the optical apparatus may have one or more of the following characteristics, limitations, and/or features:
wherein the spatial mode multiplexer is a photonic lantern;
characterized in that the spatial mode multiplexer has n single mode inputs and the few mode fiber is an n-mode fiber, where n is greater than one;
wherein the FMF is of a depressed-cladding type;
wherein an output at the end of the length of the FMF is at least one higher-order mode from a respective LP₀₁ mode input to the spatial mode multiplexer.

An aspect of the invention is an adjacent mode-interleaved WDM fiber optic telecommunications link. According to an embodiment, the adjacent mode-interleaved WDM fiber optic telecommunications link includes a first plurality of channel inputs, λₙ, each characterized by a first single spatial mode, wherein n is an integer; a first WDM having an input coupled to the plurality of λₙ channel inputs and an output characterized by the first single spatial mode; a second plurality of λₘrespective channel inputs each characterized by a second single spatial mode, wherein m=n+1, where m is an integer; a second WDM having an input coupled to the plurality of λₘ channel inputs and an output characterized by the second single spatial mode, wherein the first and second spatial modes are different and at least one of the first and second spatial modes is a higher-order mode; a spatial mode multiplexer having an input optically coupled to the first and second spatial mode outputs and an output; and a length of a few mode fiber having an input optically coupled to the output of the spatial mode multiplexer, wherein the FMF is characterized by a transmission of successive adjacent mode-interleaved channels n₁m₁, n₂m₂, n₃m₃, . . . In various embodiments, the optical apparatus may have one or more of the following characteristics, limitations, and/or features:
wherein the first and second single spatial modes are selected from the group of LP₀₁, LP₁₁ₐ, LP _{11b}, LP₂₁ₐ, LP_{21b}, and LP₀₂.

An aspect of the invention is a next-to-adjacent mode-interleaved WDM fiber optic telecommunications link. According to an embodiment, the next-to-adjacent mode-interleaved WDM fiber optic telecommunications link includes a first plurality of channel inputs, λₙ, each characterized by a first single spatial mode, wherein n is an integer; a first WDM having an input coupled to the plurality of λₙ channel inputs and an output characterized by the first single spatial mode; a second plurality of λₘ respective channel inputs each characterized by a second single spatial mode, wherein m=n+1, where m is an integer; a second WDM having an input coupled to the plurality of λₘ channel inputs and an output characterized by the second single spatial mode; a third plurality of λₚ respective channel inputs each characterized by a third single spatial mode, wherein p=m+1, where p is an integer; a third WDM having an input coupled to the plurality of λₚ channel inputs and an output characterized by the third single spatial mode, wherein the first, second, and third spatial modes are different and at least two of the first, second, and third spatial modes are higher-order modes; a spatial mode multiplexer having an input optically coupled to the first, second, and third spatial mode outputs and an output; and a length of a few mode fiber having an input optically coupled to the output of the spatial mode multiplexer, wherein the FMF is characterized by a transmission of successive next-to-adjacent mode-interleaved channels n₁m₁p₁, n₂m₂p₂, n₃m₃p₃, . . . In various embodiments, the optical apparatus may have one or more of the following characteristics, limitations, and/or features:
wherein the first, second, and third single spatial modes are selected from the group of LP₀₁, LP₁₁ₐ, LP_{11b}, LP₂₁ₐ, LP_{21b}, and LP₀₂.

An aspect of the invention is a method for improved WDM digital transmission over a fiber optic link. According to an embodiment, the method includes the steps of providing a plurality of one of adjacent and next-to-adjacent WDM signal channels; mapping the adjacent or next-to-adjacent WDM signal channels into distinct fiber modes; and transmitting the distinct mode adjacent or next-to-adjacent WDM signal channels along a length of a few mode fiber. In various embodiments, the optical apparatus may have one or more of the following characteristics, limitations, and/or features:
further comprising demultiplexing the transmitted distinct mode adjacent or next-to-adjacent WDM signal channels at an output of the few mode fiber into individual single wavelength channels; and inputting the individual single wavelength channels into a receiving component.

### BRIEF DESCRIPTION OF THE FIGURES

FIG. 1 illustrates characteristics of a few-mode analog transmission channel: (a) and (b): photograph and schematic of a photonic lantern spliced to a few-mode fiber; (c) the depressed-cladding index profile of a 6-mode FMF; (d) mode profiles at the output of the photonic lantern and after 1 km of FMF; (e) impulse response of the 3 modes used in experiment, all according to illustrative embodiments of the invention.

FIG. 2 graphically illustrates a comparison of FMF and SMF in (a) transmitted (left axis) and back scattered (right axis) power versus input optical power; (b) detected RF power of fundamental wave and intermodulation distortion from the 3^{rd} order (IMD3) versus input optical power with a fixed modulation depth; (c) Detected RF power of fundamental wave and IMD3 versus RF modulation power with a fixed input optical power, according to illustrative embodiments of the invention.

FIG. 3A graphically illustrates a comparison of mode-diversity modalities with all-in-single mode WDM transmission in nonlinear crosstalk; FIG. 3B graphically illustrates SFDR (limited by nonlinear crosstalk) versus input optical power, according to illustrative embodiments of the invention.

FIG. 4A schematically illustrates a mode-interleaved WDM system where adjacent WDM channels are transmitted on different spatial modes; FIG. 4B schematically illustrates a mode-interleaved WDM system where next-to-adjacent WDM channels are transmitted on different spatial modes, according to illustrative embodiments of the invention.

FIG. 5 schematically illustrates a multiplexer for a mode-interleaved WDM system with adjacent WDM channels transmitted on different spatial modes, according to an illustrative embodiment of the invention.

FIG. 6 schematically illustrates a multiplexer for a mode-interleaved WDM system with next-to-adjacent WDM channels transmitted on different spatial modes, according to an illustrative embodiment of the invention.

### DETAILED DESCRIPTION OF NON-LIMITING, EXEMPLARY EMBODIMENTS OF THE INVENTION

The embodied fiber optic communication apparatus and methods utilize few mode fiber (FMF) as a primary enabling component for fiber optic-based communication transmission apparatus (systems, links), associated methods, and applications thereof.

### Few-Mode Analog Transmission Channel

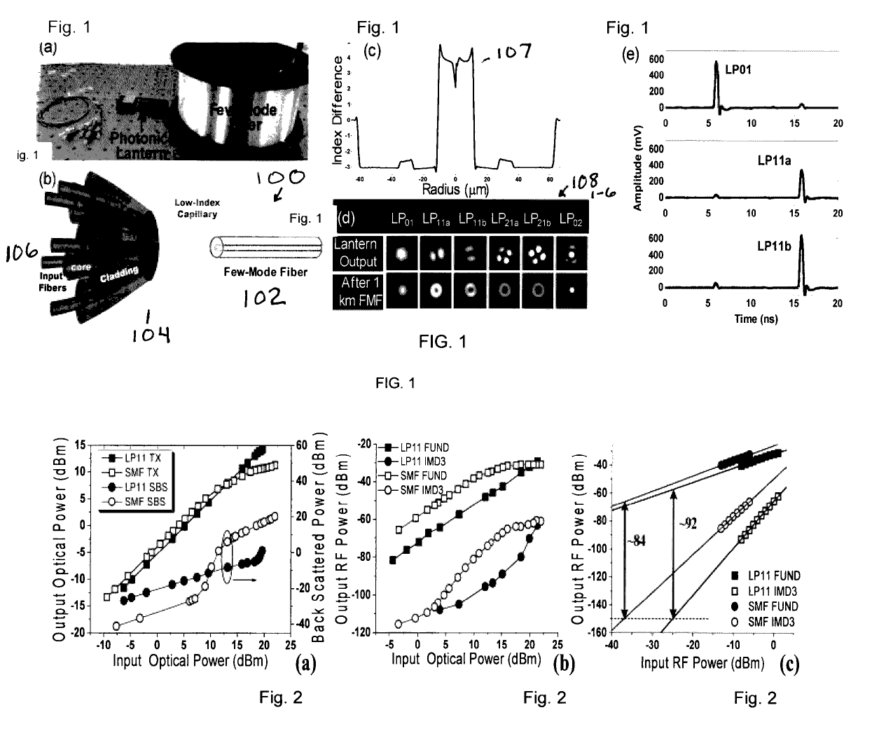

A few-mode analog transmission channel 100 includes a FMF 102 and a mode-selective photonic lantern (PL) 104, as shown in FIGS. 1(a) and (b). A 3-mode and 6-mode FMF were used in this example, both of which are of the depressed-cladding type as indicated by the profile 107 shown in FIG. 1(c). The mode-selective PL 104 converts six single-mode inputs from input single mode fibers (SMFs) 106 into the six spatial modes 108₁₋₆ of the FMF 102 (FIG. 1(d)). The PL 104 was fabricated by inserting six input fibers into a fluorine-doped capillary with an index difference of 4E-3 and then tapering the entire structure adiabatically. The output mode intensity patterns of the PL and those at the end of a 1 km length of the FMF 102 are shown in FIG. 1(d), demonstrating excellent mode selectivity. The insertion loss of the PL was below 1.5 dB for all of the six modes. Mode crosstalk of the few-mode channel was measured by the impulse-response method, in which a narrow pulse was sent into each input port, transmitted through the entire link and received by a high-speed photo-detector. Distributed crosstalk due to the fiber is below the noise floor. The observed discrete crosstalk was entirely due to the PL, as can be seen from the non-ideal purities of the modes at the lantern output in FIG. 1(d), and this crosstalk level was less than −9 dB, as shown in FIG. 1(e) (Note: this discrete crosstalk was not important for the investigation as we only transmit and detect one mode (per wavelength)).

### Experimental Results

### Single-Channel Analog Transmission

We first compare the single channel results between the FMF link and the SMF link. A two-tone-modulated (4 GHz & 4.103 GHz) light wave via a dual-parallel MZM (DP-MZM) was amplified, filtered and launched into the LP₁₁ mode of a 20 km length of FMF or into a 20 km length of SMF. The core radius of the FMF is about 11.5 um compared with 4 um for the SMF. The effective areas of these modes were all about 3.5 times larger than that of the SMF, leading to reduced fiber nonlinearity. The attenuation coefficient for the LP₁₁ mode was 0.27 dB/km at 1550 nm, which is moderately larger than that of SMF at 0.21 dB/km. As shown inn FIG. 2(a), the stimulated Brillouin scattering (SBS) threshold of the FMF reaches approximately 17 dBm, about 9 dB larger than that of SMF. The linear transmission regime is limited to input powers below 13 dBm, 7 dB higher than that for the SMF. Higher input power leads to stronger receive fundamental RF power with good linearity, as shown in FIG. 2(b). The lower receive RF power for the FMF link in the linear regime was attributed to the 1.2 dB excess fiber loss and the lower efficiency of the free-space photodetector for the LP₁₁ mode. In addition to the increased SBS threshold, the Kerr nonlinearity was reduced, leading to effective suppression of the third-order intermodulation distortion (IMD3) for the FMF link in comparison with the SMF link for the same input optical power. IMD3 is mediated by the FWM process in which the energy is transferred from the two sideband tones to the IMD3 tone. With decreased IMD3 power and larger attainable fundamental power, we achieved a 7.9 dB improvement in SFDR, as shown in FIG. 2(c), measured at the optical power of 18 dBm into the PL input port.

### Suppression of WDM Transmission Penalty

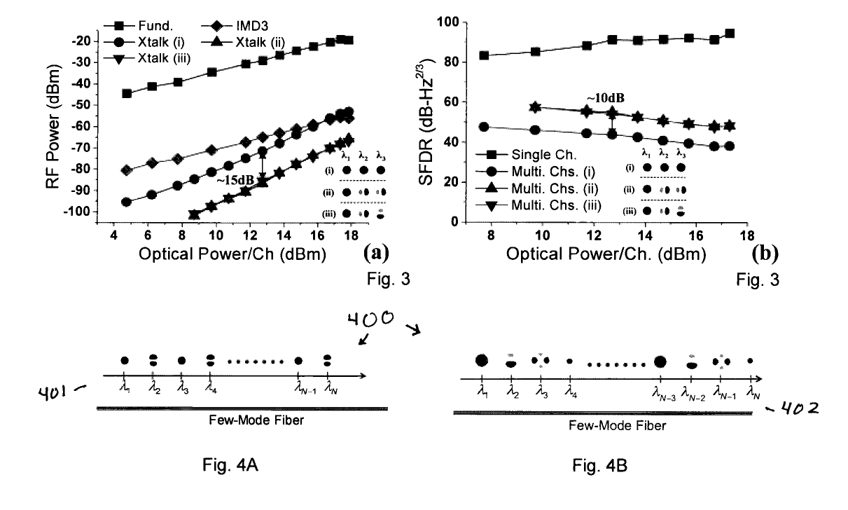

We demonstrated suppression of WDM transmission penalty using three channels with a channel spacing of 100 GHz. The large effective area is helpful in reducing WDM penalty, in a similar way to single-channel transmission. More importantly, spatial mode orthogonality and walk-off (reduction in over-lapping integral and phase mismatch among the interacting waves) lead to much larger reduction in WDM penalty. In our experiment, we used a 3-mode FMF, which was sufficient to introduce spatial mode orthogonality and walk-off even though the effective area is only increased by a factor of two. The shortest wavelength was designated as the target channel and the other two channels acted as interfering channels, transferring intermodulation distortion to the target channel through fiber nonlinearity. Three different configurations were used to demonstrate the effectiveness of nonlinearity suppression using mode diversity: (i) no mode diversity: all three wavelengths were on the LP₀₁ mode; (ii) the target channel was on the LP₀₁ mode and the interfering channels were both on the LP₁₁ₐ mode; and (iii) same as (ii) except the two interfering channels were on LP₁₁ₐ or LP_{11b}, respectively (see insets in FIG. 3). FIG. 3(a) compares the nonlinear crosstalk in WDM transmission with and without mode diversity. The nonlinear crosstalk increases with input optical power with a slope of 3 while IMD3 increases with a slope of 2. This is because nonlinear crosstalk comes from FWM of the target channel carrier, the interfering channel carrier and its sideband, while IMD3 comes from the beating between the sidebands of the two tones in the target channel. The FWM nonlinear crosstalk easily surpasses the noise floor and sets the lower bound for SFDR. The reduction in SFDR due to nonlinear crosstalk can reach a few tens of dB as shown in FIG. 3(b). This WDM penalty is most serious when all channels are in the same spatial mode. When mode diversity was implemented (case (ii) and (iii)), a 15 dB suppression of the crosstalk equivalent to a 10 dB increase in SFDR was obtained. Similar performance for cases (ii) and (iii) were most likely due to strong coupling of the degenerate of the LP₁₁ₐ or LP_{11b} modes. This level of FWM crosstalk suppression, although already very significant, was in fact much smaller than theoretically possible because the mode-diversity condition was not completely satisfied due to discrete mode crosstalk of the PL as shown in FIG. 1(e). Better crosstalk performance can be achieved in devices such as the structured directional coupler reported by B. Huang, C. Xia, G. Matz, N. Bai, and G. Li, in Optical Fiber Communication Conference/National Fiber Optic Engineers Conference 2013(Optical Society of America, Anaheim, Calif., 2013), p. JW2A.25, which not only improve WDM nonlinear crosstalk penalty but enable mode-division multiplexed transmission of analog signals.

Here, we demonstrated what we believe to be the first analog fiber-optic link using high-order modes in FMFs to improve SFDR for single-channel transmission exploiting the large effective area of FMF and, to reduce WDM penalties exploiting spatial mode orthogonality and walk-off due to intermodal phase mismatch. Using a 6-mode FMF, single-channel SFDR was improved by 8 dB. Inter-channel nonlinear crosstalk in WDM transmission was suppressed by 15 dB using mode-diversity in a 3-mode fiber.

### Mode-Interleaved WDM (Digital) Transmission Systems

Wavelength-division multiplexing (WDM), in which multiple wavelengths each carrying independent information has become a mainstay in fiber optical communication systems.

An aspect of the invention is a mode-interleaved WDM system 400 enabling significantly reduced cross-phase modulation and four-wave mixing. An example embodiment is shown in FIG. 4 where the ‘adjacent’ 401 (FIG. 4(A)) and ‘next-to-adjacent’ 402 (FIG. 4(B)) channels are transmitted in different spatial modes.

The embodied mode-interleaved WDM solution is somewhat analogous to polarization-interleaving in which adjacent WDM channels are transmitted on different polarizations. However, polarization interleaving cannot be used for today's coherent WDM systems because they are polarization multiplexed, meaning both polarizations are used on each WDM channel to carry information. Mode-interleaving provides nonlinearity mitigation for polarization-multiplexed WDM systems. In addition, the number of modes a fiber can support can be larger than two, as shown in FIG. 4(B). The performance of mode interleaving is expected to improve dramatically in comparison with polarization interleaving because of the increased degree of freedom in mode diversity and because each mode has distinct propagation constants as explained above.

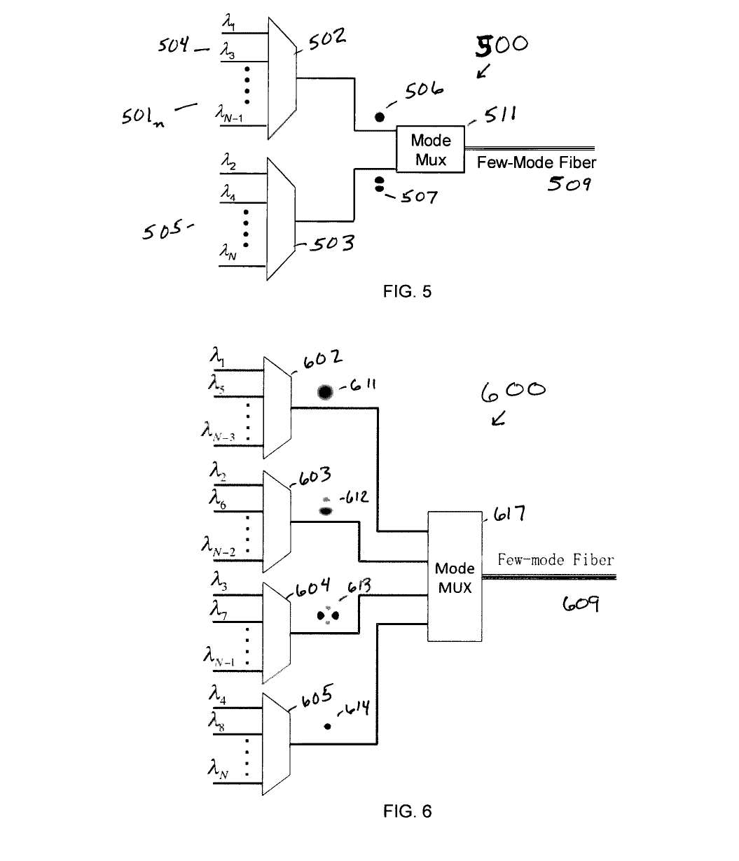

FIG. 5 illustrates an exemplary scheme 500 for multiplexing ‘adjacent’ mode-interleaved WDM channels 501ₙ onto a few-mode fiber 509, in which the odd (504) and even (505) channels are carried on the LP₀₁ 506 and LP₁₁ 507 modes, respectively. In this approach, the odd channels are multiplexed using a WDM multiplexer 502, and the even channels are multiplexed using another WDM multiplexer 503. The odd and even channels are then combined into the FMF 509 using a mode multiplexer 511 such as, e.g., the mode-selective photonic lantern 104 described above.

FIG. 6 illustrates an exemplary scheme 600 similar to that illustrated by FIG. 5, where ‘next-to-adjacent’ modes are transmitted on different spatial modes. FIG. 6 shows a 4-mode example but the configuration can be applied to arbitrary number of modes. Generally, N WDM multiplexers (four in FIG. 6) 602, 603, 604, 605 are used to combine equally spaced wavelength channels together. The wavelength interval is N times the minimum wavelength difference between any two wavelength channels of the whole system. The different WDMs cover different wavelength groups. The output of each WDM multiplexer is converted to a unique spatial mode (611, 612, 613, 614) and injected into FMF 609 through the mode-selective photonic lantern 617.

Mode-interleaved WDM systems can be applied to unrepeatered links, periodically-amplified long-haul transmission systems. Amplification can be provided by either EDFA or Raman amplifiers or both.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of ” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of ” and “consisting essentially of ” shall be closed or semi-closed transitional phrases, respectively, as set forth in the United States Patent Office Manual of Patent Examining Procedures, Section 2111.03.

We claim:

1. An analog fiber optic telecommunications link, comprising:
a spatial mode multiplexer having an input and an output;
a length of a few mode fiber (FMF) having an input end,
wherein the output of the spatial mode multiplexer is optically coupled to the input of the FMF.

2. The fiber optic telecommunications link of claim 1, wherein the spatial mode multiplexer is a photonic lantern.

3. The fiber optic telecommunications link of claim 1, characterized in that the spatial mode multiplexer has n single mode inputs and the few mode fiber is an n-mode fiber, where n is greater than one.

4. The fiber optic telecommunications link of claim 1, wherein the FMF is of a depressed-cladding type.

5. The fiber optic telecommunications link of claim 1, wherein an output at the end of the length of the FMF is at least one higher-order mode from a respective LP₀₁ mode input to the spatial mode multiplexer.

6. An adjacent mode-interleaved WDM fiber optic telecommunications link, comprising:
a first plurality of channel inputs, λₙ, each characterized by a first single spatial mode, wherein n is an integer;
a first WDM having an input coupled to the plurality of λₙ channel inputs and an output characterized by the first single spatial mode;
a second plurality of λₘ respective channel inputs each characterized by a second single spatial mode, wherein m=n+1, where m is an integer;
a second WDM having an input coupled to the plurality of λₘ channel inputs and an output characterized by the second single spatial mode, wherein the first and second spatial modes are different and at least one of the first and second spatial modes is a higher-order mode;
a spatial mode multiplexer having an input optically coupled to the first and second spatial mode outputs and an output; and
a length of a few mode fiber having an input optically coupled to the output of the spatial mode multiplexer,
wherein the FMF is characterized by a transmission of successive adjacent mode-interleaved channels n₁m₁, n₂m₂, n₃m₃, . . .

7. The adjacent mode-interleaved WDM fiber optic telecommunications link of claim 6, wherein the first and second single spatial modes are selected from the group of LP₀₁, LP₁₁ₐ, LP_{11b}, LP₂₁ₐ, LP_{21b}, and LP₀₂.

8. A next-to-adjacent mode-interleaved WDM fiber optic telecommunications link, comprising:
a first plurality of channel inputs, λₙ, each characterized by a first single spatial mode, wherein n is an integer;
a first WDM having an input coupled to the plurality of λₙ channel inputs and an output characterized by the first single spatial mode;
a second plurality of λₘ respective channel inputs each characterized by a second single spatial mode, wherein m=n+1, where m is an integer;
a second WDM having an input coupled to the plurality of λₘ channel inputs and an output characterized by the second single spatial mode;
a third plurality of λₚ respective channel inputs each characterized by a third single spatial mode, wherein p=m+1, where p is an integer;
a third WDM having an input coupled to the plurality of λₚ channel inputs and an output characterized by the third single spatial mode,
wherein the first, second, and third spatial modes are different and at least two of the first, second, and third spatial modes are higher-order modes;
a spatial mode multiplexer having an input optically coupled to the first, second, and third spatial mode outputs and an output; and
a length of a few mode fiber having an input optically coupled to the output of the spatial mode multiplexer,
wherein the FMF is characterized by a transmission of successive next-to-adjacent mode-interleaved channels n₁m₁p₁, n₂m₂p₂, n₃m₃P₃, . . .

9. The next-to-adjacent mode-interleaved WDM fiber optic telecommunications link of claim 8, wherein the first, second, and third single spatial modes are selected from the group of LP₀₁, LP₁₁ₐ, LP_{11b}, LP₂₁ₐ, LP_{21b}, and LP₀₂.

10. A method for improved WDM digital transmission over a fiber optic link, comprising:
providing a plurality of one of adjacent and next-to-adjacent WDM signal channels;
mapping the adjacent or next-to-adjacent WDM signal channels into distinct fiber modes; and
transmitting the distinct mode adjacent or next-to-adjacent WDM signal channels along a length of a few mode fiber.

11. The method of claim 10, further comprising:
demultiplexing the transmitted distinct mode adjacent or next-to-adjacent WDM signal channels at an output of the few mode fiber into individual single wavelength channels; and
inputting the individual single wavelength channels into a receiving component.
